(19) United States
(12) Patent Application Publication
(10) Pub. No.: US 2008/0102341 A1
(43) Pub. Date: May 1, 2008

(54) High intensity complex membrane and membrane-electrode assembly including the same

(76) Inventor: Ki Sub Lee, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/647,440

(22) Filed: Dec. 27, 2006

(30) Foreign Application Priority Data
Oct. 31, 2006 (KR) 10-2006-0106822

(51) Int. Cl. H01M 4/94; H01M 8/10

(52) U.S. Cl. 429/33; 429/44

(57) ABSTRACT

The membrane-electrode assembly includes: a high intensity film with a shape of a porous thin plate having a high intensity; an electrolyte solution which is impregnated into the high intensity film by applying heat and pressure in a state of being sprayed on the high intensity film, thereby forming a high intensity complex membrane; porous catalyst electrode layers which are respectively coupled on both sides of the high intensity film which is impregnated with the electrolyte solution, precious metal being sprayed thereon; and gas diffusion layers which are respectively coupled on both outer sides of the catalyst electrode layer so as to support the catalyst electrode layer 120 and to evenly diffuse fuel gas.

### CROSS-REFERENCE TO RELATED APPLICATION

This application claims priority to and the benefit of Korean Patent Application No. 10-2006-0106822 filed in the Korean Intellectual Property Office on Oct. 31, 2006, the entire contents of which are incorporated herein by reference.

### FIELD

The present invention relates to a high intensity complex membrane and a membrane-electrode assembly including the same.

### BACKGROUND

A membrane-electrode assembly of a fuel cell includes a polymer electrolyte membrane, a gas diffusion layer, and electrodes (anode and cathode). Hydrogen supplied to the cathode is divided into hydrogen ions and electrons. The hydrogen ions move to the anode through the electrolyte layer and the electrons move to the anode through an external circuit. At the anode, oxygen ions and hydrogen ions react so as to generate water. Finally hydrogen and oxygen are coupled so as to generate electricity, water, and heat.

There various components affecting on the performance of membrane-electrode assembly (MEA) of a fuel cell. These components include the performance of the polymer electrolyte membrane, interfacial resistance in the MEA, etc. Examples of the polymer electrolyte membrane include a hydrocarbon group membrane and a fluorine group membrane.

Most of the hydrocarbon group membranes are formed of carbon and hydrogen. The hydrocarbon group membrane is cheap and can be manufactured through a simple manufacturing process. However, the hydrocarbon group membrane has poor durability.

Conversely, the fluorine group membrane in which fluorine is contained in polymer structure is expensive and is manufactured through a complicated process. However it has excellent durability and stability. For this reason, the fluorine group membrane is generally used as the MEA.

However, a single layer of the fluorine group membrane cannot be thin because of problems in the manufacturing process and the physical intensity. Generally as the thickness of the membrane increases, resistance of the membrane is increased and the performance of the MEA deteriorates.

The MEA may be divided into a five-layer MEA and a three-layer MEA according to the number of the layers, and resistance generated at the contact surface of respective layers of the MEA has great effect on the performance of the MEA.

The five-layer MEA can be more easily treated than the three-layer MEA, but since the five-layer MEA is manufactured by applying a hot press of a catalyst layer in a solid layer and an electrolyte membrane on a gas diffusion layer, contact area between the catalyst layer and the electrolyte membrane is small, and interfacial resistance of the five-layer MEA is relatively greater than that of the three-layer MEA.

The three-layer MEA is manufactured by coating a catalyst electrode layer on a separator by spraying, screen printing, or by casting knife and then transmitting the coated catalyst electrode layer into an electrolyte membrane by pressing the electrolyte membrane at a high pressure and temperate.

Since such a decal method coats the catalyst electrode layer on the separator, there is an advantage that deformation of the membrane due to solvent contained in slurry of catalyst can be prevented. However, since the pressing process is added and the catalyst electrode layer in a solid state from which solvent is removed is transmitted into the electrolyte membrane, there is a drawback that the contact area between the catalyst electrode layer and the electrolyte membrane is decreased so that interfacial resistance is increased.

Accordingly, a MEA which can be easily manufactured and has a small interfacial resistance would be highly desirable.

### SUMMARY OF THE INVENTION

The present invention has been made in an effort to provide a membrane-electrode assembly having advantages of a good contact area between a catalyst electrode layer and a complex membrane and having a small interfacial resistance.

An exemplary embodiment of the present invention provides a membrane-electrode assembly including: a high intensity film with a shape of a porous thin plate having a high intensity; an electrolyte solution which is impregnated into the high intensity film by applying heat and pressure in a state of being sprayed on the high intensity film, thereby forming a high intensity complex membrane; porous catalyst electrode layers which are respectively coupled on both sides of the high intensity film which is impregnated with the electrolyte solution, precious metal being sprayed thereon; and gas diffusion layers which are respectively coupled on both outer sides of the catalyst electrode layer so as to support the catalyst electrode layer 120 and to evenly diffuse fuel gas.

The high intensity film may be a PTFE (polytetra fluoro ethylene) film with porosity higher than about 80%.

The electrolyte solution may be one of the electrolyte solutions of a polystyrene group, polysulfonic group, polyetereterketone group, and polyimide group including non-fluorosulfonic acid of about 10 to 20% by weight, or electrolyte solution including perfluorosulfonic acid group of about 10 to20% by weight.

The electrolyte solution may be impregnated into the high intensity film by pressing for 30 seconds at a temperature of 60 degrees Celsius such that the electrolyte solution is maintained in a liquid state when the catalyst electrode layers are coupled.

The electrolyte solution may have a viscosity at which the electrolyte solution can be maintained to be sprayed on a surface of the high intensity film until the catalyst electrode layers are coupled.

### BRIEF DESCRIPTION OF THE DRAWINGS

FIG. 1 is a drawing showing a manufacturing process of a high intensity complex membrane according to an exemplary embodiment of the present invention.

FIG. 2 is a cross sectional view of a high intensity complex membrane according to an exemplary embodiment of the present invention.

FIG. 3 is a cross sectional view showing a five-layer MEA according to an exemplary embodiment of the present invention.

### DETAILED DESCRIPTION OF THE EMBODIMENTS

An exemplary embodiment of the present invention will hereinafter be described in detail with reference to the accompanying drawings.

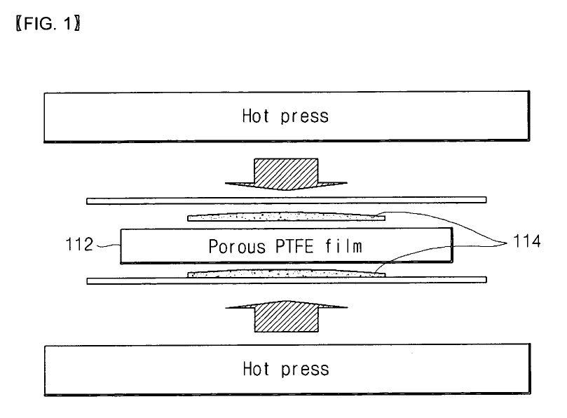

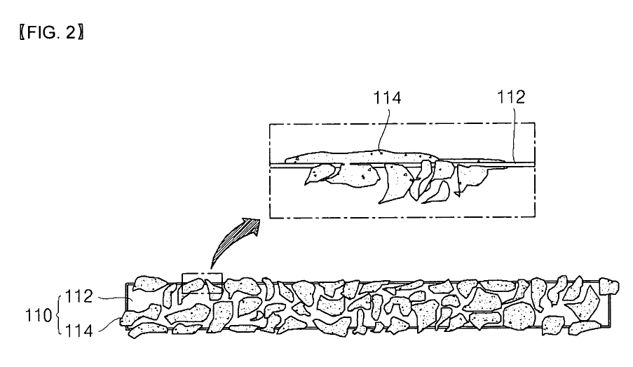

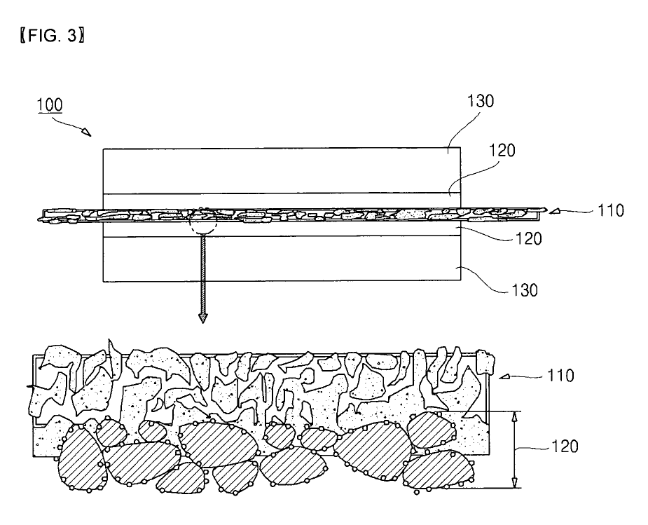

FIG. 1 is a drawing showing a manufacturing process of a high intensity complex membrane according to an exemplary embodiment of the present invention. FIG. 2 is a cross sectional view of a high intensity complex membrane according to an exemplary embodiment of the present invention. FIG. 3 is a cross sectional view showing a five-layer MEA according to an exemplary embodiment of the present invention.

As shown in FIG. 1 to FIG. 3, a membrane-electrode assembly (hereinafter also referred to as a “MEA”) 100 according to an exemplary embodiment of the present invention is formed by forming a high intensity complex membrane 110 by impregnating a surface of a high intensity film 112 which is made of PTFE (polytetra fluoro ethylene, which is a fluorine-based resin generally known as TEFLON) film with an electrolyte solution 114 of high density and high viscosity, and by bonding catalyst electrode layers 120 and gas diffusion layers 130 onto the high intensity complex membrane 110 by compression.

As shown in FIG. 1 to FIG. 3, the high intensity film 112 is made of PTFE material. PTFE has high chemical and physical stability, and a film having a small thickness and a high intensity with excellent porosity can be made of PTFE. The high intensity complex membrane 110 which has the PTFE film as a support member and the electrolyte solution 114 is coated thereon has a higher intensity and a higher performance than other electrolyte membranes which are commonly used.

It is preferable that the PTFE film having the porosity higher than 80% such that the electrolyte solution 114 is easily impregnated.

The high intensity complex membrane 110 is formed by impregnating both sides of the high intensity film 112 with the electrolyte solution 114 by applying heat and pressure.

The electrolyte solution 114 may be an electrolyte solution selected from the following groups: a polystyrene group, polysulfonic group, polyetereterketone group, and polyimide group including non-fluorosulfonic acid of about 10 to 20% by weight, or electrolyte solution including perfluorosulfonic acid group of about 10 to 20% by weight. In an exemplary embodiment of the present invention, the high intensity complex membrane 110 is made of a nafion solution of DUPONT Company including perfluorosulfonic acid group of about 20% by weight.

The electrolyte solution 114 preferably has a high viscosity such that the electrolyte solution 114 sprayed on the catalyst electrode layer 120 can maintain a constant thickness without spreading out or dripping off.

As shown in FIG. 2, by pressing for 30 seconds at a temperature of 60 degrees Celsius after spraying the electrolyte solution 114 on the high intensity film 112, the electrolyte solution 114 is impregnated into the high intensity film 112 and a portion of electrolyte solution remains on a surface of the high intensity film 112 in a liquid state. As shown in FIG. 1, the electrolyte solution could not be immediately hot pressed so that the steel plate is supplied. The steel plate is shown in FIG. 1 without a number.

If such a hot pressed process is too long, all solvent among the electrolyte solution 114 is evaporated, so the electrolyte solution 114 is converted to a solid state on the high intensity film 112. If so, since electrolyte material in a solid state and the catalyst electrode layer 120 which has a rough surface and is porous should be coupled, contact area between the two layers is decreased so that coupling force is decreased. Accordingly, interfacial resistance between the high intensity film 112 and the electrolyte material layer in a solid state is increased. In order to solve this problem, it is preferable to apply heat and pressure at which the electrolyte solution 114 is not completely solidified.

If the high intensity complex membrane 110 is formed by pressing for 30 seconds under temperature of 60 degrees Celsius, the catalyst electrode layer 120 and the gas diffusion layer 130 are attached thereto.

Since a portion of the electrolyte solution 114 remains in a liquid state after the electrolyte solution 114 is impregnated into the high intensity film 112, the electrolyte solution 114 in a liquid state permeates into the catalyst electrode layer 120 when the catalyst electrode layer 120 is coupled.

Subsequently, if solvent among the electrolyte solution 114 is evaporated, the electrolyte solution 114 is changed to a solid state so as to be firmly attached to a crooked surface of the catalyst electrode layer 120, so that the contact area between the two layers is increased. Accordingly, the coupling force is increased, and the interfacial resistance is decreased.

As shown in FIG. 1 and FIG. 3, a surface of the catalyst electrode layer 120 has high luminance and is porous, and is coated by a precious metal catalyst. The two catalyst electrode layers 120, serving as an anode and a cathode, are respectively coupled to both sides of the high intensity complex membrane 110.

One of the catalyst electrode layers 120 is a cathode (reduction electrode or air electrode) where hydrogen, which is fuel, is divided into hydrogen ions and electrons. The other of the catalyst electrode layers 120 is an anode (oxidation electrode or fuel electrode) where oxygen and hydrogen ions are coupled so as to generate water, heat, and electrical energy. The ions generated in this way move through the high intensity complex membrane 110 so as to generate electrical energy.

The gas diffusion layers 130 are respectively attached to the outsides of the pair of the catalyst electrode layers 120 so as to support the catalyst electrode layer 120, and evenly diffuse fuel gas to the catalyst electrode layer 120.

The two catalyst electrode layers 120 and the two gas diffusion layers 130 are attached to the high intensity complex membrane 110, thereby forming a five-layer MEA 100 which is comprised of five layers.

The five-layer MEA 100 has much less interfacial resistance than a conventional five-layer MEA, so that the performance of the MEA is enhanced and the performance of a fuel cell is also enhanced.

While this invention has been described in connection with what is presently considered to be practical exemplary embodiments, it is to be understood that the invention is not limited to the disclosed embodiments, but, to the contrary, is intended to cover various modifications and equivalent arrangements included within the spirit and scope of the appended claims.

As described above, according to a high intensity complex membrane and a membrane-electrode assembly including the same according to exemplary embodiments of the present invention, a high intensity film is impregnated with electrolyte solution by a pressed process so as to form a high intensity complex membrane. The catalyst electrode layers are coupled before the phase of the electrolyte solution is changed to a solid state so as to form five-layer MEA, so that contact area and coupling force between the high intensity complex membrane and the catalyst layer are increased.

Accordingly, the interfacial resistance is decreased so that the performance of the membrane-electrode assembly can be enhanced. Since the high intensity complex layer is used, the durability of the membrane-electrode assembly can also be enhanced.

What is claimed is:

1. A membrane-electrode assembly comprising:
a high intensity film shaped as a porous thin plate;
an electrolyte solution impregnated into the high intensity film by applying heat and pressure when being sprayed onto the high intensity film, thereby forming a high intensity complex membrane;
porous catalyst electrode layers which are respectively coupled on both sides of the high intensity film impregnated with the electrolyte solution, wherein precious metal is sprayed onto the porous catalyst electrode layers; and
gas diffusion layers which are respectively coupled on both outer sides of the catalyst electrode layers so as to support the catalyst electrode layers and to evenly diffuse fuel gas.

2. The membrane-electrode assembly of claim 1, wherein the high intensity film is a PTFE (polytetra fluoro ethylene) film with a porosity higher than about 80%.

3. The membrane-electrode assembly of claim 1, wherein the electrolyte solution is selected from a group consisting of: a polystyrene group, polysulfonic group, polyetereterketone group, and polyimide group including non-fluorosulfonic acid of about 10 to 20% by weight, and electrolyte solution including perfluorosulfonic acid group of about 10 to 20% by weight.

4. The membrane-electrode assembly of claim 1, wherein the electrolyte solution is impregnated into the high intensity film by pressing for about 30 seconds at a temperature of about 60 degrees Celsius such that the electrolyte solution is maintained in a liquid state when the catalyst electrode layers are coupled.

5. The membrane-electrode assembly of claim 1, wherein the electrolyte solution has a viscosity at which the electrolyte solution can be maintained to be sprayed on a surface of the high intensity film until the catalyst electrode layers are coupled.

6. The membrane-electrode assembly comprising:
a porous high intensity film;
an electrolyte solution impregnated into the high intensity film;
two porous catalyst electrode layers each respectively coupled to a different side of the high intensity film; and
two gas diffusion layers, each coupled to a respective one of the two catalyst electrode layers.

7. The membrane-electrode assembly of claim 6, wherein the high intensity film is a PTFE (polytetra fluoro ethylene) film with a porosity higher than about 80%.

8. The membrane-electrode assembly of claim 6, wherein the electrolyte solution is selected from a group consisting of: a polystyrene group, polysulfonic group, polyetereterketone group, and polyimide group including non-fluorosulfonic acid of about 10 to 20% by weight, and electrolyte solution including perfluorosulfonic acid group of about 10 to 20% by weight.

9. The membrane-electrode assembly of claim 6, wherein the electrolyte solution is impregnated into the high intensity film by pressing for about 30 seconds at a temperature of about 60 degrees Celsius such that the electrolyte solution is maintained in a liquid state when the catalyst electrode layers are coupled.

10. The membrane-electrode assembly of claim 6, wherein the electrolyte solution has a viscosity at which the electrolyte solution can be maintained to be sprayed on a surface of the high intensity film until the catalyst electrode layers are coupled.
